(19) United States
(12) Patent Application Publication
(10) Pub. No.: US 2016/0286447 A1
(43) Pub. Date: Sep. 29, 2016

(54) TECHNIQUES FOR MAINTAINING DATA CONTINUITY IN OFFLOADING WIRELESS COMMUNICATIONS

(71) Applicant: QUALCOMM Incorporated, San Diego, CA (US)

(72) Inventors: Manu SHARMA, San Diego, CA (US); Rajat PRAKASH, San Diego, CA (US); Miguel GRIOT, La Jolla, CA (US)

(21) Appl. No.: 15/080,253

(22) Filed: Mar. 24, 2016

Related U.S. Application Data
(60) Provisional application No. 62/139,502, filed on Mar. 27, 2015.

(51) Int. Cl. H04W 36/08; H04W 36/00

(52) U.S. Cl. CPC H04W 36/08; H04W 36/0033

(57) ABSTRACT

Various aspects described herein relate to maintaining data continuity for a user equipment (UE). A request can be received at a first node of a first network from at least one of a second node of the first network or a second network to update a location of the UE. A type of the request can be determined based at least in part on an identifier in the request. The request can be acknowledged without instructing a third node of the first network or the second network to cancel a context of the UE based at least in part on the type of the request.

### CLAIM OF PRIORITY UNDER 35 U.S.C. §119

The present Application for Patent claims priority to Provisional Application No. 62/139,502 entitled “TECHNIQUES FOR MAINTAINING DATA CONTINUITY IN OFFLOADING WIRELESS COMMUNICATIONS” filed Mar. 27, 2015, which is assigned to the assignee hereof and hereby expressly incorporated by reference herein.

### BACKGROUND

Described herein are aspects generally related to communication systems, and more particularly, to providing data continuity in a wireless communication system.

Wireless communication systems are widely deployed to provide various types of communication content, such as voice, data, multimedia, and so on. Typical wireless communication systems are multiple-access systems capable of supporting communication with multiple users by sharing available system resources (e.g., bandwidth, transmit power, etc.). Examples of such multiple-access systems include Code Division Multiple Access (CDMA) systems, Time Division Multiple Access (TDMA) systems, Frequency Division Multiple Access (FDMA) systems, Orthogonal Frequency Division Multiple Access (OFDMA) systems, and others. These systems are often deployed in conformity with specifications such as Third Generation Partnership Project (3GPP), 3GPP Long Term Evolution (LTE), Ultra Mobile Broadband (UMB), Evolution Data Optimized (EV-DO), Institute of Electrical and Electronics Engineers (IEEE), etc.

In cellular networks, “macro cell” base stations provide connectivity and coverage to a large number of users over a certain geographical area. A macro network deployment is carefully planned, designed, and implemented to offer good coverage over the geographical region. Even such careful planning, however, cannot fully accommodate channel characteristics such as fading, multipath, shadowing, etc., especially in indoor environments. Indoor users therefore often face coverage issues (e.g., call outages and quality degradation) resulting in poor user experience. In addition, the macro cells may not be able to sufficiently accommodate radio resources for a high number of users.

To improve indoor or other specific geographic coverage, such as for residential homes and office buildings, and/or to offload network traffic from macro cells, additional “small cell” base stations, typically operating at a lower power than the macro cell base stations, have been and are being deployed to supplement conventional macro networks. Small cell base stations may also provide incremental capacity growth, richer user experience, and so on. Additionally, in LTE, small cells have been extended into the unlicensed frequency spectrum such as the Unlicensed National Information Infrastructure (U-NII) band used by Wireless Local Area Network (WLAN) technologies. This extension of small cell LTE operation is designed to increase spectral efficiency and hence capacity of the LTE system. Accordingly, one or more devices communicating with macro cells can be handed over to the small cells, to offload at least a data portion of a connection from the macro cells. This can provide higher throughput for the data portion of the connection by utilizing the small cell, free resources of the macro cell for other devices, etc.

In some examples, the small cell used to offload the device may not be owned by the mobile network operator (MNO) of the macro cell. In such examples, a mobility management entity (MME) of the network related to the small cell may communicate with a home subscriber server (HSS) of the MNO network to authenticate the device, and one or more gateways of the network related to the small cell may communicate with one or more gateways of the MNO network to provide data services to the device. When the device is offloaded to the network of the small cell, contextual information, such as a UE address or other identifier, an IP address of the UE, routing information for the UE, etc. is deleted from an MME and gateways (e.g., serving gateways (S-GW) and PDN gateways (PDN-GW)) of the MNO network as it is assumed that this context information is no longer needed for the handed over device. If the deletion of context information occurs before the device has completed the connection setup on the small cell network, the device will not be able to maintain IP address continuity on offload. Moreover, for a dual radio device seeking to use the macro cell for a portion of the connection while simultaneously using the small cell offload for another portion of the connection, the deletion of context in the MNO network can lead to termination of the portion of the connection served by the macro cell. Moreover, the deletion of context in the MNO network can result in additional overhead to reestablish the context when the device is subsequently handed back over to the macro cell (or another macro cell in the MNO network) from the small cell.

### SUMMARY

The following presents a simplified summary of one or more aspects in order to provide a basic understanding of such aspects. This summary is not an extensive overview of all contemplated aspects, and is intended to neither identify key or critical elements of all aspects nor delineate the scope of any or all aspects. Its sole purpose is to present some concepts of one or more aspects in a simplified form as a prelude to the more detailed description that is presented later.

According to an example, a method for maintaining data continuity for a user equipment (UE) is provided. The method includes receiving, at a first node of a first network, a request from at least one of a second node of the first network or a second network to update a location of the UE, determining a type of the request based at least in part on an identifier in the request, and acknowledging the request without instructing a third node of the first network or the second network to cancel a context of the UE based at least in part on the type of the request.

According to another example, an apparatus for maintaining data continuity for a

UE is provided. The apparatus includes at least one processor coupled to a memory via a bus. The at least one processor is operable to receive, at a first node of a first network, a request from at least one of a second node of the first network or a second network to update a location of the UE, determine a type of the request based at least in part on an identifier in the request, and acknowledge the request without instructing a third node of the first network or the second network to cancel a context of the UE based at least in part on the type of the request.

In another example, an apparatus for maintaining data continuity for a UE. The apparatus includes means for receiving, at a first node of a first network, a request from at least one of a second node of the first network or a second network to update a location of the UE, means for determining a type of the request based at least in part on an identifier in the request, and means for acknowledging the request without instructing a third node of the first network or the second network to cancel a context of the UE based at least in part on the type of the request.

In a further example, a computer-readable storage medium comprising computer-executable code for maintaining data continuity for a UE is provided. The code includes code for receiving, at a first node of a first network, a request from at least one of a second node of the first network or a second network to update a location of the UE, code for determining a type of the request based at least in part on an identifier in the request, and code for acknowledging the request without instructing a third node of the first network or the second network to cancel a context of the UE based at least in part on the type of the request

To the accomplishment of the foregoing and related ends, the one or more aspects comprise the features hereinafter fully described and particularly pointed out in the claims. The following description and the annexed drawings set forth in detail certain illustrative features of the one or more aspects. These features are indicative, however, of but a few of the various ways in which the principles of various aspects may be employed, and this description is intended to include all such aspects and their equivalents.

### BRIEF DESCRIPTION OF THE DRAWINGS

FIG. 1 shows a block diagram conceptually illustrating an example of a telecommunications system, in accordance with aspects described herein.

FIG. 2 is a diagram illustrating an example of an evolved Node B and user equipment in an access network.

FIG. 3 is a diagram illustrating an example of an access network in an LTE network architecture.

FIG. 4 is a diagram illustrating an example of an access network in an LTE roaming network architecture.

FIG. 5 is a diagram illustrating an example system for maintaining data continuity for a user equipment (UE) in accordance with aspects described herein.

FIG. 6 is a flow chart of an example method for maintaining data continuity for a UE in accordance with aspects described herein.

FIGS. 7-10 are specific examples of telecommunications systems in accordance with aspects described herein.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more aspects, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Combinations of the above should also be included within the scope of computer-readable media.

Described herein are various aspects related to maintaining data continuity for a user equipment (UE) between cells of different networks. At least a portion of a connection of the UE may be handed over from one cell to another cell where the cells correspond to different core networks (e.g., different public land mobile networks (PLMN), different networks owned by different mobile network operators (MNO), etc.). In some technologies, when a data portion of a connection of a UE is handed over from a source cell of a first network to a target cell of a second network that is different from the first network, one or more nodes of the first network are instructed to delete contextual information (also referred to herein as context information, a context, a UE context, or similar terms) of the UE. For example, the contextual information may include a context as a data structure or other collection of data associated with a UE, where the context stores a UE address, an IP address, routing information, etc. of the UE. In a specific example, a home subscriber server (HSS) of the first network instructs a mobility management entity (MME) of the first network to delete the UE context in the MME, Serving Gateway (S-GW) and/or PDN Gateway (PDN-GW) (e.g., in a Cancel Location message) based on handover of the UE to a different network.

In some examples, such as where the UE being handed over for offload, the second network may utilize a UE context in the first network for at least some communications with the UE (e.g., for voice calls, related authorization, paging and/or the like, IP multimedia subsystem (IMS) services, packet switch stream (PSS) services, etc.). If the deletion of context information occurs before the UE has completed the connection setup on the second network, however, the UE may not be able to maintain IP address continuity on mobility to the second network, and thus may expend time and resources to initiate another context, which may include establishing another IP address for the UE, associating the IP address with a UE identifier, establish routing information for the UE, etc. Moreover, for a dual radio device seeking to use the first network for a portion of the connection while concurrently using the second network for another portion of the connection, the deletion of context in the first network may lead to termination of the portion of the connection served by the first network. Also, if the data portion of the connection for the UE is then handed over from the target cell back to the source cell or another cell in the first network, a new context is established for the UE by the MME of the first network. This may consume additional processing/communication resources where the UE, or at least the data portion of the connection, is frequently handed over between the first and second networks (e.g., in an offload scenario).

Accordingly, when at least a portion of a connection of the UE is being handed over from the first network to the target cell of the second network, one or more nodes of the first network (e.g., the MME) may not be instructed to delete the context of the UE to allow for continuing a data session with the UE. Rather, in the specific example above, the HSS of the first network can determine that the handover of at least the portion of the connection of the UE is to a different core network (e.g., based on an indication, network identifier, or other parameter in or related to a request to handover), and can accordingly refrain from instructing the MME of the first network to delete the context of the UE. Thus, the MME of the first network may maintain the context of the UE to facilitate session continuity over the data connection between the different networks. In addition, in this regard, the HSS can manage two or more MME identifiers (e.g., a primary and secondary MME) for a given UE, in one example.

Additionally, in an example, where at least the portion of the connection of the UE is handed over from the second network to the first network, the HSS may notify the MME of the second network that a location update to the first network is triggered due to a handover. In this case, the MME of the second network may not delete a context of the UE to facilitate continuing the data session with the UE in the future.

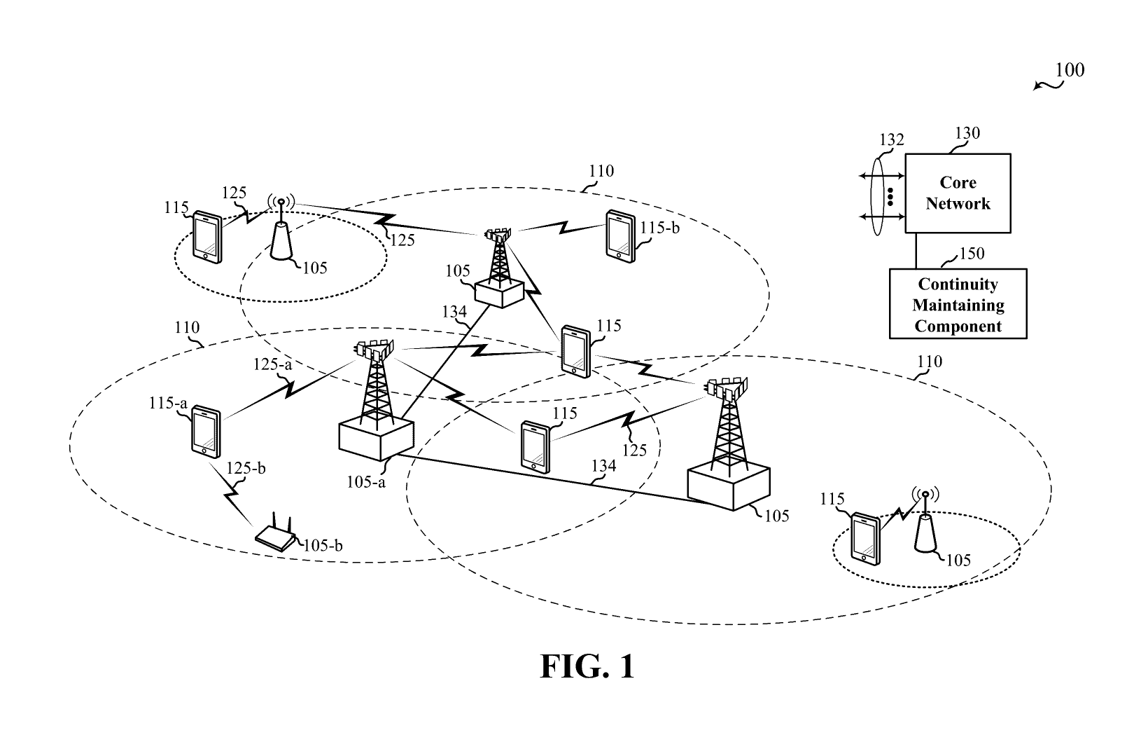

Referring first to FIG. 1, a diagram illustrates an example of a wireless communications system 100, in accordance with aspects described herein. The wireless communications system 100 includes a plurality of access points (e.g., base stations, eNBs, or WLAN access points) 105, a number of UEs 115, and a core network 130. One or more components of the core network 130 (e.g., an HSS) can include a continuity maintaining component 150 as described herein for updating a location of a UE 115 from one network to another network while maintaining data continuity for the UE 115. Some of the access points 105 may communicate with the UEs 115 under the control of a base station controller (not shown), which may be part of the core network 130 or the certain access points 105 (e.g., base stations or eNBs) in various examples. Access points 105 may communicate control information and/or user data with the core network 130 through backhaul links 132. In examples, the access points 105 may communicate, either directly or indirectly, with each other over backhaul links 134, which may be wired or wireless communication links. The wireless communications system 100 may support operation on multiple carriers (waveform signals of different frequencies). Multi-carrier transmitters can transmit modulated signals simultaneously on the multiple carriers. For example, each of communication links 125 may be a multi-carrier signal modulated according to the various radio technologies described above. Each modulated signal may be sent on a different carrier and may carry control information (e.g., reference signals, control channels, etc.), overhead information, data, etc.

In this regard, a UE 115 can be configured to communicate with one or more access points 105 over multiple carriers using carrier aggregation (CA) (e.g., with one access point 105) and/or multiple connectivity (e.g., with multiple access points 105). In either case, UE 115 can be configured with at least one primary cell (PCell) configured to support uplink and downlink communications between UE 115 and an access point 105. It is to be appreciated that there can be a PCell for each of communication links 125 between a UE 115 and a given access point 105. In addition, each of the communication links 125 can have one or more secondary cells (SCell) that can support uplink and/or downlink communications as well. In some examples, the PCell can be used to communicate at least a control channel, and the SCell can be used to communicate a data channel.

The access points 105 may wirelessly communicate with the UEs 115 via one or more access point antennas. Each of the access points 105 sites may provide communication coverage for a respective coverage area 110. In some examples, access points 105 may be referred to as a base transceiver station, a radio base station, a radio transceiver, a basic service set (BSS), an extended service set (ESS), a NodeB, eNodeB, Home NodeB, a Home eNodeB, or some other suitable terminology. The coverage area 110 for a base station may be divided into sectors making up only a portion of the coverage area (not shown). The wireless communications system 100 may include access points 105 of different types (e.g., macro, micro, and/or pico base stations). The access points 105 may also utilize different radio technologies, such as cellular and/or WLAN radio access technologies (RAT). The access points 105 may be associated with the same or different access networks or operator deployments. The coverage areas of different access points 105, including the coverage areas of the same or different types of access points 105, utilizing the same or different radio technologies, and/or belonging to the same or different access networks, may overlap.

In LTE/LTE-A network communication systems, the terms evolved Node B (eNodeB or eNB) may be generally used to describe the access points 105. The wireless communications system 100 may be a Heterogeneous LTE/LTE-A network in which different types of access points provide coverage for various geographical regions. For example, each access point 105 may provide communication coverage for a macro cell, a pico cell, a femto cell, and/or other types of cell. Small cells such as pico cells, femto cells, and/or other types of cells may include low power nodes or LPNs. A macro cell may cover a relatively large geographic area (e.g., several kilometers in radius) and may allow unrestricted access by UEs 115 with service subscriptions with the network provider. A small cell may cover a relatively smaller geographic area and may allow unrestricted access by UEs 115 with service subscriptions with the network provider, for example, and in addition to unrestricted access, may also provide restricted access by UEs 115 having an association with the small cell (e.g., UEs in a closed subscriber group (CSG), UEs for users in the home, and the like). An eNB for a macro cell may be referred to as a macro eNB. An eNB for a small cell may be referred to as a small cell eNB. An eNB may support one or multiple (e.g., two, three, four, and the like) cells. The term eNB, as used generally herein, may relate to a macro eNB and/or a small cell eNB. In an example, a small cell may operate in an “unlicensed” frequency band or spectrum, which can refer to a portion of radio frequency (RF) space that is not licensed for use by one or more wireless wide area network (WWAN) technologies, but may or may not be used by other communication technologies (e.g., wireless local area network (WLAN) technologies, such as Wi-Fi). Moreover, a network or device that provides, adapts, or extends its operations for use in an “unlicensed” frequency band or spectrum may refer to a network or device that is configured to operate in a contention-based radio frequency band or spectrum. In addition, for illustration purposes, the description below may refer in some respects to an LTE system operating on an unlicensed band by way of example when appropriate, although it is to be appreciated that such descriptions are not intended to exclude other cellular communication technologies. LTE on an unlicensed band may also be referred to herein as LTE/LTE-Advanced in unlicensed spectrum, or simply LTE, in the surrounding context.

The core network 130 may communicate with the eNBs or other access points 105 via a backhaul links 132 (e.g., S1 interface, etc.). The access points 105 may also communicate with one another, e.g., directly or indirectly via backhaul links 134 (e.g., X2 interface, etc.) and/or via backhaul links 132 (e.g., through core network 130). The wireless communications system 100 may support synchronous or asynchronous operation. For synchronous operation, the access points 105 may have similar frame timing, and transmissions from different access points 105 may be approximately aligned in time. For asynchronous operation, the access points 105 may have different frame timing, and transmissions from different access points 105 may not be aligned in time. Furthermore, transmissions in the first hierarchical layer and second hierarchical layer may or may not be synchronized among access points 105. The techniques described herein may be used for either synchronous or asynchronous operations.

The UEs 115 are dispersed throughout the wireless communications system 100, and each UE 115 may be stationary or mobile. A UE 115 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A UE 115 may be a cellular phone, a personal digital assistant (PDA), a wireless modem, a wireless communication device, a handheld device, a tablet computer, a laptop computer, a cordless phone, a wearable item such as a watch or glasses, a wireless local loop (WLL) station, or the like. A UE 115 may be able to communicate with macro eNodeBs, small cell eNodeBs, relays, and the like. A UE 115 may also be able to communicate over different access networks, such as cellular or other WWAN access networks, or WLAN access networks.

The communication links 125 shown in wireless communications system 100 may include uplink (UL) transmissions from a UE 115 to an access point 105, and/or downlink (DL) transmissions, from an access point 105 to a UE 115. The downlink transmissions may also be called forward link transmissions while the uplink transmissions may also be called reverse link transmissions. The communication links 125 may carry transmissions of each hierarchical layer which, in some examples, may be multiplexed in the communication links 125. The UEs 115 may be configured to collaboratively communicate with multiple access points 105 through, for example, Multiple Input Multiple Output (MIMO), carrier aggregation (CA), Coordinated Multi-Point (CoMP), multiple connectivity (e.g., CA with each of one or more access points 105) or other schemes. MIMO techniques use multiple antennas on the access points 105 and/or multiple antennas on the UEs 115 to transmit multiple data streams. Carrier aggregation may utilize two or more component carriers on a same or different serving cell for data transmission. CoMP may include techniques for coordination of transmission and reception by a number of access points 105 to improve overall transmission quality for UEs 115 as well as increasing network and spectrum utilization.

As mentioned, for example, UE 115-a may communicate with eNB 105-a over communication link 125-a to receive access to a wireless network via one or more components of core network 130. In an example, UE 115-a may be handed over to eNB 105-b to offload UE 115-a communications from the communication link 125-a to communication link 125-b, and thus conserve radio resources of eNB 105-a. eNBs 105-a and 105-b may correspond to different core networks, and eNB 105-b may access the core network 130 of eNB 105-a to facilitate an offload configuration such that eNB 105-b uses a connection with the core network 130 of eNB 105-a for at least certain services (e.g., voice calls, IMS services, PSS services, etc.). Thus, core network 130 may employ a continuity maintaining component 150 to maintain a context of the UE 115-a (e.g., an IP context, such as in an IMS) for at least some communications through the communication link 125-b via eNB 105-b despite the UE 115-a being handed over to a eNB 105-b corresponding to a different core network (e.g., a different MNO). In this regard, initiation of a context for UE 115-a in core network 130 may not be needed to provide some functionality of core network 130 (e.g., voice calls, IMS services, PSS services, etc.) to UE 115-a via eNB 105-b.

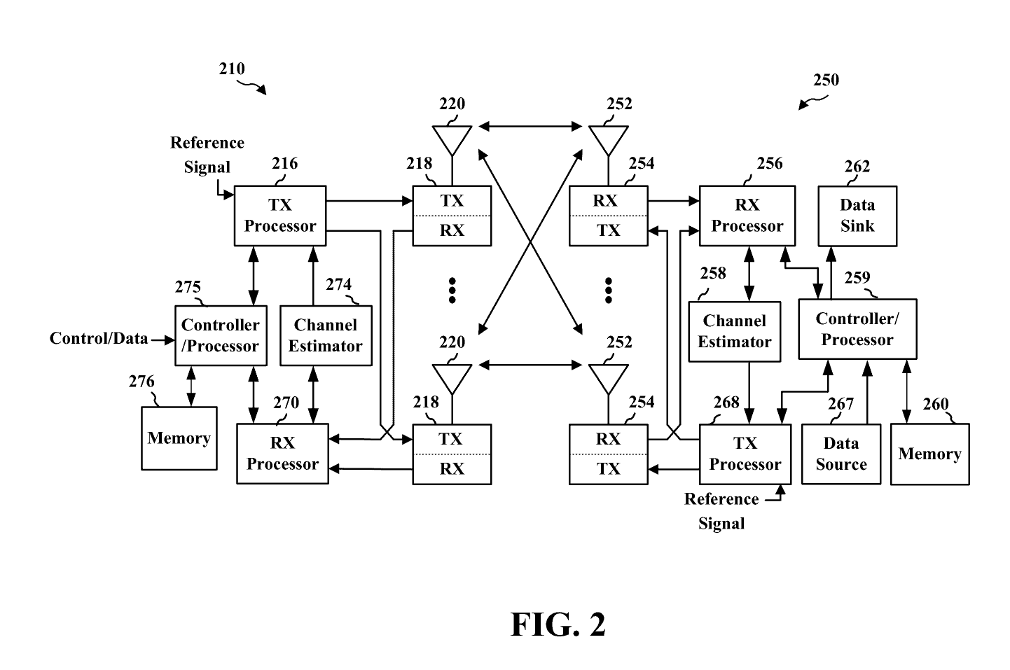

FIG. 2 is a block diagram of an eNB 210 in communication with a UE 250 in an access network. In the DL, upper layer packets from the core network are provided to a controller/processor 275. The controller/processor 275 implements the functionality of the L2 layer. In the DL, the controller/processor 275 provides header compression, ciphering, packet segmentation and reordering, multiplexing between logical and transport channels, and radio resource allocations to the UE 250 based on various priority metrics. The controller/processor 275 is also responsible for HARQ operations, retransmission of lost packets, and signaling to the UE 250.

The transmit (TX) processor 216 implements various signal processing functions for the L1 layer (i.e., physical layer). The signal processing functions includes coding and interleaving to facilitate forward error correction (FEC) at the UE 250 and mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols are then split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 274 may be used to determine the coding and modulation scheme, as well as for spatial processing. The channel estimate may be derived from a reference signal and/or channel condition feedback transmitted by the UE 250. Each spatial stream is then provided to a different antenna 220 via a separate transmitter 218TX. Each transmitter 218TX modulates an RF carrier with a respective spatial stream for transmission.

At the UE 250, each receiver 254RX receives a signal through its respective antenna 252. Each receiver 254RX recovers information modulated onto an RF carrier and provides the information to the receive (RX) processor 256. The RX processor 256 implements various signal processing functions of the L1 layer. The RX processor 256 performs spatial processing on the information to recover any spatial streams destined for the UE 250. If multiple spatial streams are destined for the UE 250, they may be combined by the RX processor 256 into a single OFDM symbol stream. The RX processor 256 then converts the OFDM symbol stream from the time-domain to the frequency domain using a Fast Fourier Transform (FFT). The frequency domain signal comprises a separate OFDM symbol stream for each subcarrier of the OFDM signal. The symbols on each subcarrier, and the reference signal, is recovered and demodulated by determining the most likely signal constellation points transmitted by the eNB 210. These soft decisions may be based on channel estimates computed by the channel estimator 258. The soft decisions are then decoded and deinterleaved to recover the data and control signals that were originally transmitted by the eNB 210 on the physical channel. The data and control signals are then provided to the controller/processor 259.

The controller/processor 259 implements the L2 layer. The controller/processor can be associated with a memory 260 that stores program codes and data. The memory 260 may be referred to as a computer-readable medium. In the UL, the controller/processor 259 provides demultiplexing between transport and logical channels, packet reassembly, deciphering, header decompression, control signal processing to recover upper layer packets from the core network. The upper layer packets are then provided to a data sink 262, which represents all the protocol layers above the L2 layer. Various control signals may also be provided to the data sink 262 for L3 processing. The controller/processor 259 is also responsible for error detection using an acknowledgement (ACK) and/or negative acknowledgement (NACK) protocol to support HARQ operations.

The modulation and multiple access scheme employed by the eNB 210 and UE 250 may vary depending on the particular telecommunications standard being deployed. In LTE applications, orthogonal frequency-division multiplexing (OFDM) is used on the downlink (DL) and single-carrier frequency division multiple access (SC-FDMA) is used on the uplink (UL) to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations. These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), Ultra Mobile Broadband (UMB), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

In the UL, a data source 267 is used to provide upper layer packets to the controller/processor 259. The data source 267 represents all protocol layers above the L2 layer. Similar to the functionality described in connection with the DL transmission by the eNB 210, the controller/processor 259 implements the L2 layer for the user plane and the control plane by providing header compression, ciphering, packet segmentation and reordering, and multiplexing between logical and transport channels based on radio resource allocations by the eNB 210. The controller/processor 259 is also responsible for HARQ operations, retransmission of lost packets, and signaling to the eNB 210.

Channel estimates derived by a channel estimator 258 from a reference signal or feedback transmitted by the eNB 210 may be used by the TX processor 268 to select the appropriate coding and modulation schemes, and to facilitate spatial processing. The spatial streams generated by the TX processor 268 are provided to different antenna 252 via separate transmitters 254TX. Each transmitter 254TX modulates an RF carrier with a respective spatial stream for transmission.

The UL transmission is processed at the eNB 210 in a manner similar to that described in connection with the receiver function at the UE 250. Each receiver 218RX receives a signal through its respective antenna 220. Each receiver 218RX recovers information modulated onto an RF carrier and provides the information to a RX processor 270. The RX processor 270 may implement the L1 layer.

The controller/processor 275 implements the L2 layer. The controller/processor 275 can be associated with a memory 276 that stores program codes and data. The memory 276 may be referred to as a computer-readable medium. In the UL, the controller/processor 275 provides demultiplexing between transport and logical channels, packet reassembly, deciphering, header decompression, control signal processing to recover upper layer packets from the UE 250. Upper layer packets from the controller/processor 275 may be provided to the core network. The controller/processor 275 is also responsible for error detection using an ACK and/or NACK protocol to support HARQ operations.

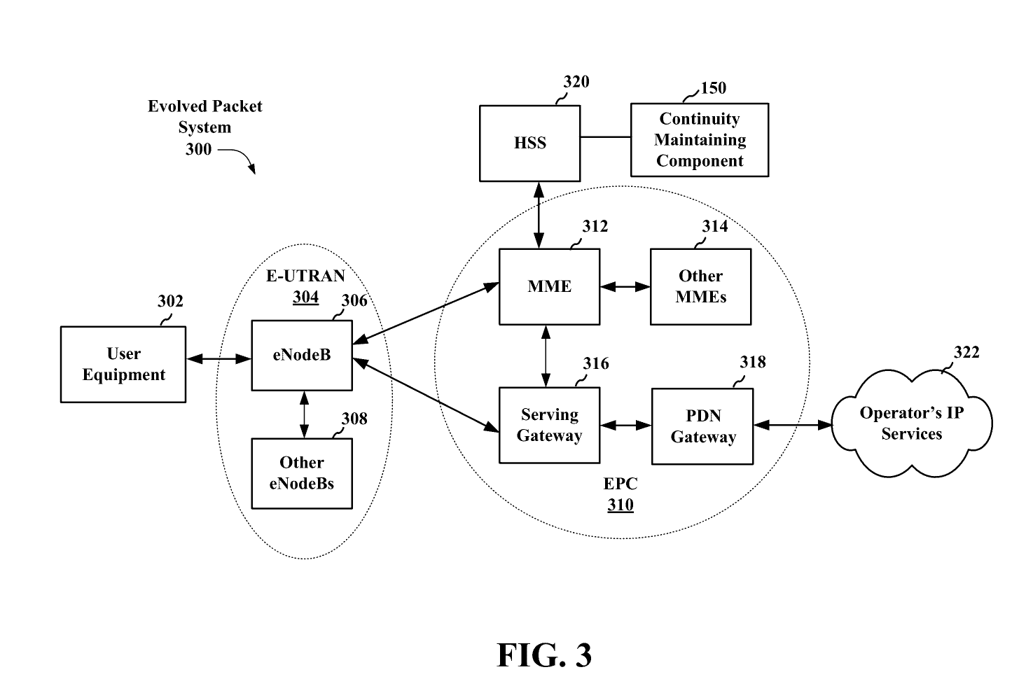

FIG. 3 is a diagram illustrating an LTE network architecture 300 employing various apparatuses. The LTE network architecture 300 may be referred to as an Evolved Packet System (EPS) 300. The EPS 300 may include one or more user equipment (UE) 302 (which may represent or include UE 115 of FIG. 1, UE 250 of FIG. 2, etc.), an Evolved UMTS Terrestrial Radio Access Network (E-UTRAN) 304, an Evolved Packet Core (EPC) 310, a Home Subscriber Server (HSS) 320, and an Operator's IP Services 322. The EPC 310, HSS 320, and/or Operator's IP Services 322 may be part of a core network (e.g., core network 130 in FIG. 1) for an MNO. HSS 320 can include or can be in communication with a continuity maintaining component 150 as described herein that can update a location of a UE 302 from one network to another network (though only one network is shown in FIG. 3) while maintaining data continuity for the UE 302. The EPS 300 can interconnect with other access networks, but for simplicity those entities/interfaces are not shown. As shown, the EPS provides packet-switched services, however, as those skilled in the art will readily appreciate, the various concepts presented herein may be extended to networks providing circuit-switched services.

The E-UTRAN includes the evolved Node B (eNB) 306 and other eNBs 308, one or more of which may represent or may include access point 105 of FIG. 1, eNodeB 210 of FIG. 2, etc. The eNB 306 provides user and control plane protocol terminations toward the UE 302. The eNB 306 may be connected to the other eNBs 308 via an X2 interface (i.e., backhaul). The eNB 306 may also be referred to by those skilled in the art as a base station, a base transceiver station, a radio base station, a radio transceiver, a transceiver function, a basic service set (BSS), an extended service set (ESS), or some other suitable terminology. The eNB 306 provides an access point to the EPC 310 for a UE 302. Examples of UEs 302 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, or any other similar functioning device. The UE 302 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 306 is connected by an S1 interface to the EPC 310. The EPC 310 includes a Mobility Management Entity (MME) 312, other MMEs 314, a Serving Gateway 316, and a Packet Data Network (PDN) Gateway 318. The MME 312 is the control node that processes the signaling between the UE 302 and the EPC 310. Generally, the MME 312 provides bearer and connection management. All user IP packets are transferred through the Serving Gateway 316, which itself is connected to the PDN Gateway 318. The PDN Gateway 318 provides UE IP address allocation as well as other functions. The PDN Gateway 318 is connected to the Operator's IP Services 322. The Operator's IP Services 322 include the Internet, the Intranet, an IP Multimedia Subsystem (IMS), and a PS Streaming Service (PSS). In FIG. 3, E-UTRAN 304, EPC 310, HSS 320, and Operator's IP Services 322 can relate to a home public land mobile network (PLMN) of the UE 302 such that components outside of the home PLMN (HPLMN) need not be contacted to authenticate the UE 302.

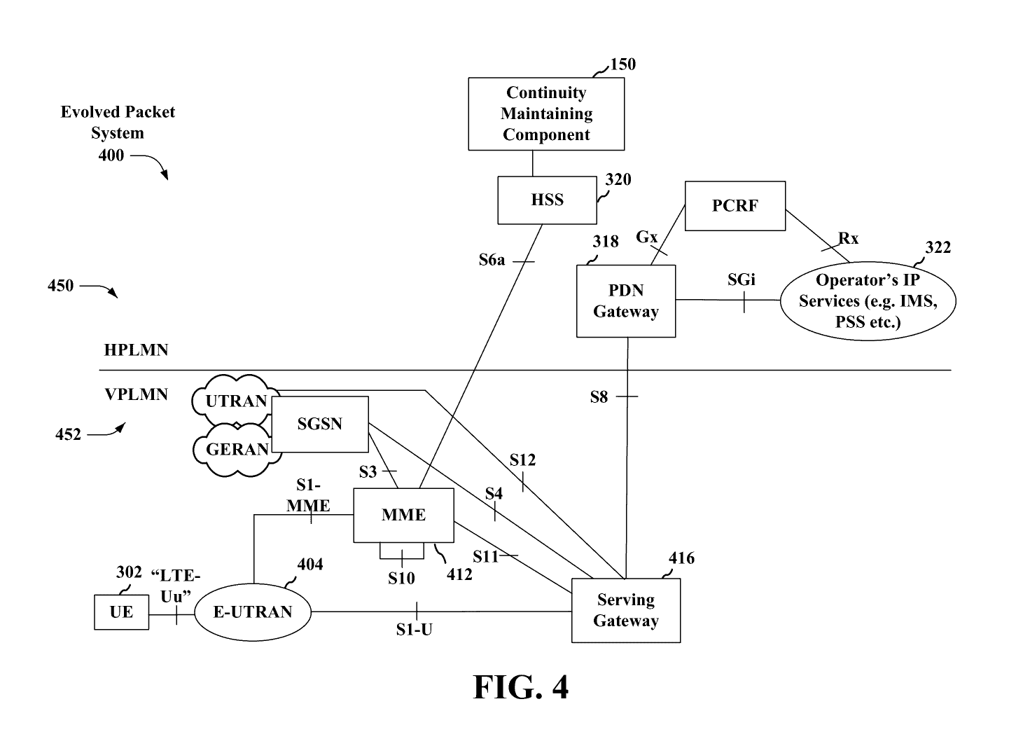

FIG. 4 is a diagram illustrating another LTE network architecture 400 employing various apparatuses, which may be referred to as an EPS, as described, for example, in 3GPP technical specification (TS) 23.401. EPS 400 includes an HPLMN 450 of a UE 302 and a visited PLMN (VPLMN) 452 to which the UE 302 is connected to receive wireless network access (e.g., access to Operator's IP Services 322 of the HPLMN and/or other data connectivity, which may include voice calls, IMS services, PSS services, etc.). In this example, UE 302 can communicate with the E-UTRAN 404 of the VPLMN, which provides access to various nodes of the VPLMN, such as an MME 412, serving gateway 416, etc. In an example, MME 412 can determine that the UE 302 is not part of the VPLMN, and can accordingly authenticate the UE 302 by communicating with one or more components of the UE's HPLMN, such as HSS 320. Once authenticated, MME 412 can establish one or more bearers between the UE 302 and one or more components of the VPLMN, such as serving gateway 416, to access other network components. In an example, serving gateway 416 can facilitate communications between UE 302 and PDN gateway 318 of the HPLMN such to provide Operator IP Services 322 to the UE 302. This configuration is also referred to as a roaming architecture to allow the UE 302 to connect to a PLMN where available even if the UE 302 cannot connect to a E-UTRAN of its HPLMN. In the roaming architecture the Serving Gateway 416 of the VPLMN 452 is connected to the PDN Gateway 318 of the HPLMN 450 via the S8 interface. Further, the MME 412 of the VPLMN 452 is connected to the HSS 320 in the HPLMN 450 via the S6a interface. There may not be an interface between the MME 412 of the VPLMN 452 and an MME 312 of the HPLMN 450.

In an example, to meet growing data demand, MNOs may increase network capacity by adding new spectrum and deploying small cells, as described above. The small cells may use one or more of a plurality of radio access technologies, such as LTE, Wi-Fi, etc. and may be deployed by the MNO or an independent Service Provider (SP). Correspondingly, for example, protocols are defined for integrating the various deployment models of small cells into a network architecture, such as a EPS 300, 400, etc. When an MNO wishes to use an independent SPs small cell network for offload, some issues may arise. As described, offloading can refer to transferring at least a portion of a connection between the UE 302 and a first network (e.g., a HPLMN) to a second network (e.g., VPLMN). The portion of the connection can include at least a data portion, and in an example, the UE 302 can retain a voice portion of the connection with the HPLMN. Offloading the data portion of the connection for the UE 302 in this regard may improve UE 302 data throughput by using the small cell, may free resources of the HPLMN (and/or a corresponding eNB) for other UEs, etc. The S8/S6a based roaming architecture described above may be used to allow the offload between the small cell network (e.g., as VPLMN 452) and the MNO (e.g., as HPLMN 450). In an example, an interface may be added between the MME 412 of the VPLMN 452 and an MME 312 of the HPLMN 450, but this may present additional requirements and processing, which may not be desirable.

Where the HPLMN 450 and the VPLMN 452 correspond to different core networks (which may be owned/operated by different entities), continuity for the portion of the connection may not typically be provided as the portion is handed over between the HPLMN 450 and VPLMN 452. Accordingly, HSS 320 can include a continuity maintaining component 150 as described herein for updating a location of a UE 115 from one network to another network while maintaining data continuity for the UE 115. In this example, the HSS 320 may concurrently manage multiple (e.g., two) MME Identities for a single connected UE 302 (e.g., that of the MNO MME 312 and that of the Offload Network MME 412). As described further below, enhanced signaling between network nodes (e.g., MME 312/412 and HSS 320) and enhanced behavior of the HSS 320 based on this signaling are provided to manage the multiple MME Identities for the UE 302 and ensure that UE 302 context is not deleted in the network nodes (e.g., that the UE 302 context or continuity is maintained) while a session is being transferred between the two networks. Thus, the UE context (e.g., an IP address of the UE 302) can be maintained as the device moves between the networks. Maintaining continuity by not deleting the context can become important where the UE 302 frequently performs handover between the networks (e.g., HPLMN 450 and VPLMN 452) as the context can be reused (e.g., continuity can be maintained) and thus does not need to be reestablished. Maintaining continuity by not deleting the context can also be beneficial in the case of a dual radio UE 302 that can be concurrently connected to the MNO network (e.g., HPLMN 450) and the Offload network (e.g., VPLMN 452).

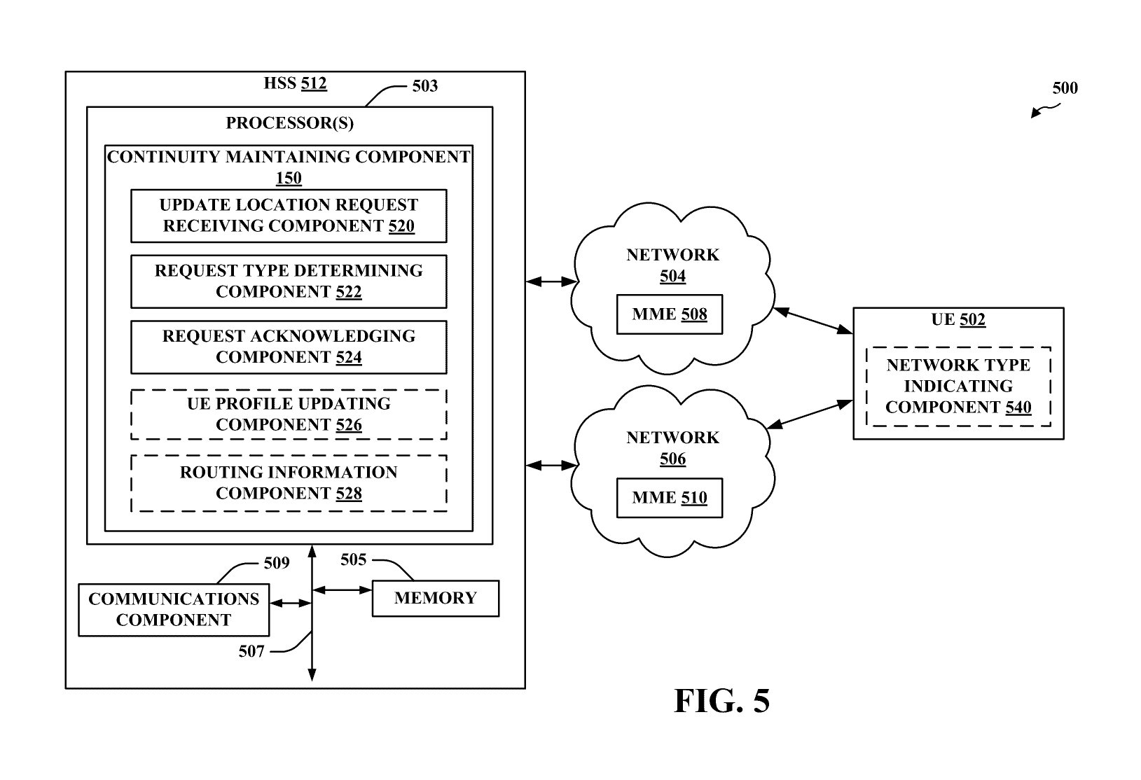

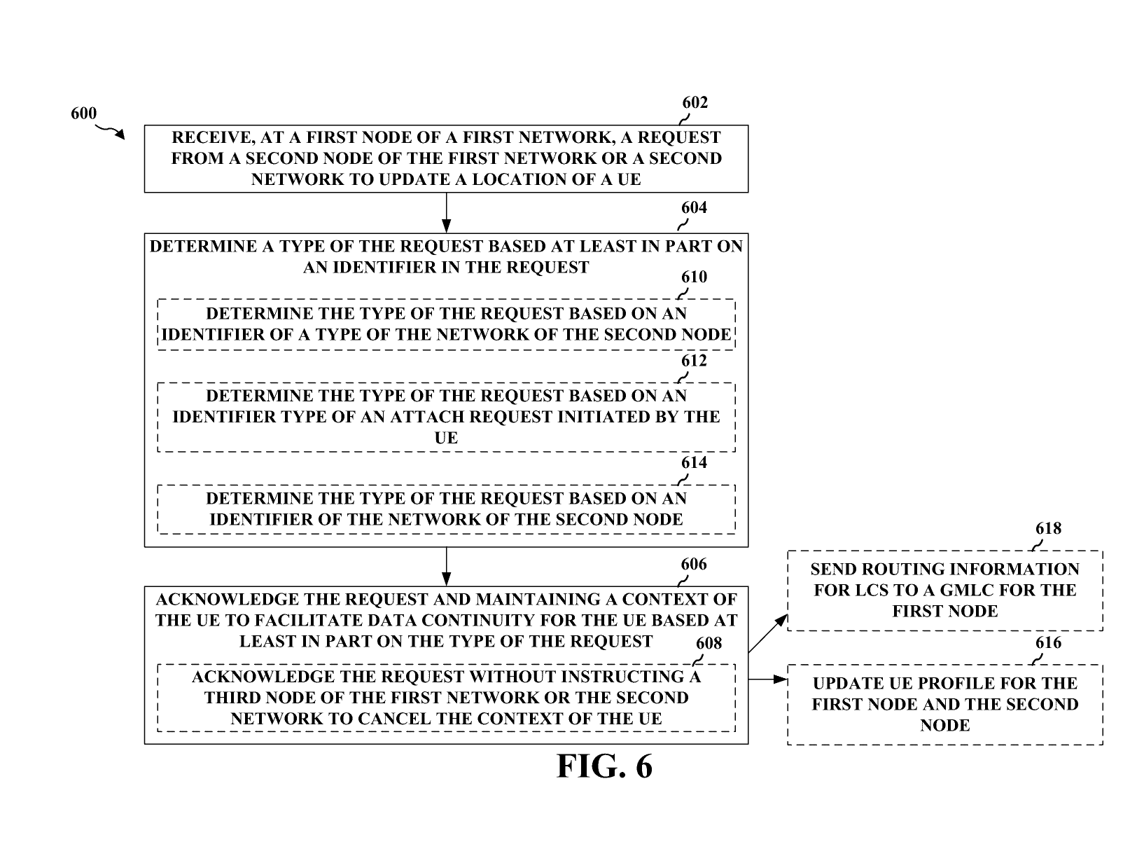

Referring to FIGS. 5 and 6, aspects are depicted with reference to one or more components and one or more methods that may perform the actions or functions described herein. In an aspect, the term “component” as used herein may be one of the parts that make up a system, may be hardware or software or some combination thereof, and may be divided into other components. Although the operations described below in FIG. 6 are presented in a particular order and/or as being performed by an example component, it should be understood that the ordering of the actions and the components performing the actions may be varied, depending on the implementation. Moreover, it should be understood that the following actions or functions may be performed by a specially-programmed processor, a processor executing specially-programmed software or computer-readable media, or by any other combination of a hardware component and/or a software component capable of performing the described actions or functions.

FIG. 5 illustrates an example system 500 for updating a network location of a UE. System 500 includes a UE 502 that communicates over network 504 to receive wireless network access, and can handover at least a portion of a connection to network 506. UE 502 can include UE 115 of FIG. 1, UE 250 of FIG. 2, UE 302 of FIGS. 3 and 4, etc. In an example, network 504 can be an HPLMN of the UE 502 and network 506 can be a VPLMN of the UE 502, which may correspond to a small cell network. In addition, in an example, UE 502 may handover at least a data portion of the connection to network 506 to offload from network 504, as described above. Network 504 may include an MME 508, and network 506 may also include an MME 510. MMEs 508 and 510 can include components of a core network 130 of FIG. 1, MMEs 312, 314, 412 of FIGS. 3 and 4, etc. The MMEs 508 and 510 may communicate with an HSS 512 to authenticate the UE 502 and/or notify the HSS 512 of the handover of at least the portion of the connection from network 504 to network 506. HSS can include a component of a core network 130 of FIG. 1, HSS 320 of FIGS. 3 and 4, etc.

HSS 512 can include one or more processors 503 and/or a memory 505 that may be communicatively coupled, e.g., via one or more buses 507, and may operate in conjunction with or otherwise implement a continuity maintaining component 150 as described herein for updating a location of a UE 502 from one network to another network while maintaining data continuity for the UE 502. For example, the various operations related to continuity maintaining component 150 may be implemented or otherwise executed by one or more processors 503 and, in an aspect, can be executed by a single processor, while in other aspects, different ones of the operations may be executed by a combination of two or more different processors. For example, in an aspect, the one or more processors 503 may include any one or any combination of application specific integrated circuit (ASIC), microprocessors, microcontrollers, digital signal processors (DSPs), field programmable gate arrays (FPGAs), programmable logic devices (PLDs), state machines, gated logic, discrete hardware circuits, etc., as described. Further, for example, the memory 505 may be a non-transitory computer-readable medium that includes, but is not limited to, random access memory (RAM), read only memory (ROM), programmable ROM (PROM), erasable PROM (EPROM), electrically erasable PROM (EEPROM), a magnetic storage device (e.g., hard disk, floppy disk, magnetic strip), an optical disk (e.g., compact disk (CD), digital versatile disk (DVD)), a smart card, a flash memory device (e.g., card, stick, key drive), a register, a removable disk, and any other suitable medium for storing software and/or computer-readable code or instructions that may be accessed and read by a computer or one or more processors 503. Moreover, memory 505 or computer-readable storage medium may be resident in the one or more processors 503, external to the one or more processors 503, distributed across multiple entities including the one or more processors 503, etc. In one example, the one or more processors 503 may include one or more processors described herein, such as TX processor 216, RX processor 256, controller/processor 259, TX processor 268, RX processor 270, controller/processor 275, etc. Similarly, for example, memory 505 may include one or more memories described herein, such as memory 260, memory 276, etc.

In particular, the one or more processors 503 and/or memory 505 may execute actions or operations defined by continuity maintaining component 150 or its subcomponents. For instance, the one or more processors 503 and/or memory 505 may execute actions or operations defined by an update location request receiving component 520 for receiving an update location request from one or more network nodes indicating that at least a portion of a connection with a UE is being handed over from one network to another network. In an aspect, for example, update location request receiving component 520 may include hardware (e.g., one or more processor modules of the one or more processors 503) and/or computer-readable code or instructions stored in memory 505 and executable by at least one of the one or more processors 503 to perform the specially configured request receiving operations described herein.

Further, for instance, the one or more processors 503 and/or memory 505 may execute actions or operations defined by a request type determining component 522 for determining a type of the update location request such to determine whether to instruct one or more nodes to delete a context of the UE as a result of the handover. In an aspect, for example, request type determining component 522 may include hardware (e.g., one or more processor modules of the one or more processors 503) and/or computer-readable code or instructions stored in memory 505 and executable by at least one of the one or more processors 503 to perform the specially configured request type determining operations described herein.

Further, for instance, the one or more processors 503 and/or memory 505 may execute actions or operations defined by a request acknowledging component 524 for acknowledging the update location request with or without instructing the one or more nodes to delete the context of the UE. In an aspect, for example, request acknowledging component 524 may include hardware (e.g., one or more processor modules of the one or more processors 503) and/or computer-readable code or instructions stored in memory 505 and executable by at least one of the one or more processors 503 to perform the specially configured request acknowledging operations described herein.

Further, for instance, the one or more processors 503 and/or memory 505 may optionally execute actions or operations defined by a UE profile updating component 526 for updating a UE profile to one or more nodes. In an aspect, for example, UE profile updating component 526 may include hardware (e.g., one or more processor modules of the one or more processors 503) and/or computer-readable code or instructions stored in memory 505 and executable by at least one of the one or more processors 503 to perform the specially configured profile updating operations described herein.

Further, for instance, the one or more processors 503 and/or memory 505 may optionally execute actions or operations defined by a routing information component 528 for communicating information regarding one or more MMEs for location services (LCS). In an aspect, for example, routing information component 528 may include hardware (e.g., one or more processor modules of the one or more processors 503) and/or computer-readable code or instructions stored in memory 505 and executable by at least one of the one or more processors 503 to perform the specially configured routing information operations described herein.

HSS 512 may also include a communications component 509 that may be coupled to one or more processors 503 and/or memory 505 via one or more buses 507. Communications component 509 may enable communication internally among components of HSS 512, and/or may include one or more interfaces that enable communication with external devices, such as components of networks 504, 506, UE 502, etc. As such, communications component 509 can be configured to establish and maintain communications with one or more entities utilizing hardware, software, and/or services as described herein. In an aspect, for example with respect to external communications, communications component 509 may further include transmit chain components (e.g., protocol layer entities, processor(s), modulator(s), antenna) and receive chain components (e.g., protocol layer entities, processor(s), demodulator(s), antenna) associated with one or more transmitters and receivers, respectively, or one or more transceivers, operable for interfacing with external devices over a wired or wireless connection. In one example, communications component 509 may include a network interface card that includes one or more wired or wireless interfaces for coupling to one or more networks (e.g., local area networks, wide area networks, etc.), which may include network 504, network 506, and/or a network that facilitates communicating with networks 504, 506. In an aspect, for example, communications component 509 may operate in cooperation with continuity maintaining component 150, or components thereof, to exchange and/or generate the communications and/or signaling described herein.

Additionally, in one example, memory 505 may include a data store, which can be any suitable combination of hardware and/or software, that provides for mass storage of information, parameters, databases, and programs employed in connection with aspects described herein. For example, a data store may be a computer-readable storage medium, such as a data repository, for computer-executable code and/or applications not currently being executed by one or more processors 503. In an aspect, for example, a data store may store one or more computer-executable codes defining continuity maintaining component 150, or components thereof, and/or data associated therewith, when HSS 512 is not executing continuity maintaining component 150, or components thereof or otherwise.

In addition, UE 502 may optionally include a network type indicating component 540 for indicating a type of network to which at least a portion of the connection is being handed over. Though not shown, UE 502 can similarly include one or more processors and/or memory, such as processors 503 and memory 505, or other processors or memories (e.g., a transmit/receive processor, modem processor, baseband processor, etc.) and/or other components of a radio frequency front end that may be used to indicate the type of network in signaling that can be received by one or more of networks 504, 506 and provided to HSS 512.

FIG. 6 illustrates an example method 600 for updating a location of at least a portion of a connection of a UE from one network to another network. Method 600 includes, at Block 602, receiving, at a first node of a first network, a request from a second node of the first network or a second network to update a location of a UE. In an aspect, update location request receiving component 520, e.g., in conjunction with the one or more processors 503, memory 505, and/or communications component 509, can receive, at the first node (e.g., the HSS 512) of the first network, the request from the second node (e.g., MME 508 or 510) of the first network (e.g., network 504) or the second network (e.g., network 510) to update the location of the UE (e.g., UE 502). As described further herein, the UE 502 can initiate an attach request to the second network 506. MME 510 can perform authentication/security by communicating with the HSS 512 (e.g., via communications component 509) for the UE 502 to ensure the UE 502 can access network 506. In a specific example, network type indicating component 540 can indicate a type of the network 506 in the attach request generated and transmitted by the UE 502 (e.g., as a type indicating secondary network where the UE 502 is retaining a portion of its connection with network 504 as the primary network), which can be forwarded to the HSS 512, as described further herein. It is to be appreciated that network type indicating component 540 may indicate the network type (e.g., as being a primary network or secondary network, as described herein) for each attach requests and/or only requests when offloading to a secondary network (thus absence of a network type in the attach request may indicate primary network). In other specific examples, UE 502 may indicate a type of an attach request (e.g., for the purpose of handover). In any case, as described further herein, the type of network, type of attach request, etc. may be used to determine behavior at the HSS 512 for the corresponding update location request.

Method 600 may also include, at Block 604, determining a type of the request based at least in part on an identifier in the request. In an aspect, request type determining component 522, e.g., in conjunction with the one or more processors 503 and/or memory 505, may determine the type of the request based at least in part on the identifier in the request. For example, the identifier in the request may correspond to or otherwise facilitate determination that the request relates to handover of at least a portion of the connection of the UE 502 to a different network (e.g., from network 504 to network 506).

Method 600 also includes, at Block 606, acknowledging the request and maintaining a context of the UE to facilitate data continuity for the UE based at least in part on the type of the request. In an aspect, request acknowledging component 524, e.g., in conjunction with the one or more processors 503, memory 505, and/or communications component 509, can acknowledge the request (e.g. by transmitting an acknowledgement to a third node of the first network, such as an MME 508, 510) and maintain the context of the UE 502 to facilitate data continuity for the UE 502 based at least in part on the type of the request. In this regard, for certain types of requests, a context of the UE can be maintained in one or more nodes to facilitate data continuity for the UE when moving between network 504 and network 506. For example, maintaining the context of the UE 502 can include maintaining an IP address for the UE 502 such that the UE 502 can continue using the same IP address when accessing network 504 and/or 506, and thus a new UE context (or IP address) need not be established for each handover between the networks 504 and 506.

In an example, acknowledging the request while maintaining the context of the UE at Block 606 may optionally include, at Block 608, acknowledging the request without instructing a third node of the first network or the second network to cancel the context of the UE. In an aspect, request acknowledging component 524, e.g., in conjunction with the one or more processors 503, memory 505, and/or communications component 509, can acknowledge the request (e.g. by transmitting an acknowledgement to a third node of the first network, such as an MME 508, 510) without instructing the third node (e.g., MME 508 or 510) of the first network (e.g., network 504) or the second network (e.g., network 510) to cancel the context of the UE 502. Without receiving the instruction (or receiving an instruction to not cancel the context), MME 508, 510 may maintain the context of the UE 502 to facilitate data continuity for requests related to networks 506 and 508.

In an example, determining the type of the request at Block 604 may optionally include, at Block 610, determining the type of the request based on an identifier of a type of the network of the second node. In an aspect, request type determining component 522, e.g., in conjunction with the one or more processors 503 and/or memory 505, can determine the type of the request based on the identifier of the type of the network of the second node (e.g., MME 508 or 510). As described, for example, UE 502 may be communicating with network 504, and may initiate an attach request to network 506 for at least a portion of the UE's connection. In this regard, network type indicating component 540 may indicate a “secondary network” type in the attach request, referring to network 506. MME 510 can receive the attach request, and can transmit an update location request to the HSS 512 that indicates the “secondary network” type. When this type is received, request type determining component 522 can determine that the update location request is for a secondary network, and that the UE context in the first network (e.g., in network 504) should be maintained (e.g., should not be deleted). Accordingly, request acknowledging component 524 can determine to refrain from instructing the MME 508 or other nodes of network 504 to delete a context of the UE 502. In addition, in this example, continuity maintaining component 150 can manage two MME Identifiers (e.g., for MME 508 and 510) for the UE 502, as described further herein.

In another example, determining the type of the request at Block 604 may optionally include, at Block 612, determining the type of the request based on an identifier type of an attach request initiated by the UE. In an aspect, request type determining component 522, e.g., in conjunction with the one or more processors 503 and/or memory 505, can determine the type of the request (e.g., a handover type or other type) based on an identifier type of an attach request initiated by the UE 502. As described, for example, UE 502 may initiate an attach request to network 506 for at least a portion of the UE's connection, and may indicate a “handover” type in the attach request. MME 510 can receive the attach request, and can transmit an update location request to the HSS 512 indicating the “handover” type. When this type is received, request type determining component 522 can determine that the update location request is for a secondary network, and that the UE context in the first network (e.g., in network 504) should be maintained (e.g., should not be deleted). Accordingly, request acknowledging component 524 can determine to refrain from instructing the MME 508 or other nodes of network 504 to delete a context of the UE 502. In addition, in this example, continuity maintaining component 150 can manage two MME Identifiers (e.g., for MME 508 and 510) for the UE 502, as described further herein.

In yet another example, determining the type of the request at Block 604 may optionally include, at Block 614, determining the type of the request based on an identifier of the network of the second node. In an aspect, request type determining component 522, e.g., in conjunction with the one or more processors 503 and/or memory 505, can determine the type of the request based on the identifier of the network of the second node. Request type determining component 522 may determine the identifier in one or more messages from the MME 510 or other nodes of the associated network 506, and may determine whether the network is different based on comparing the identifier to an identifier of the network related to MME 508 or HSS 512 (e.g., network 504). Where the network related to MME 510 is determined to be different than that of MME 508 or HSS 512, request type determining component 522 can determine that the update location request is for a secondary network, and that the UE context in the first network (e.g., in network 504) should be maintained (e.g., should not be deleted). Accordingly, request acknowledging component 524 can determine to refrain from instructing the MME 508 or other nodes of network 504 to delete a context of the UE 502. In addition, in this example, continuity maintaining component 150 can manage two MME Identifiers (e.g., for MME 508 and 510) for the UE 502, as described further herein.

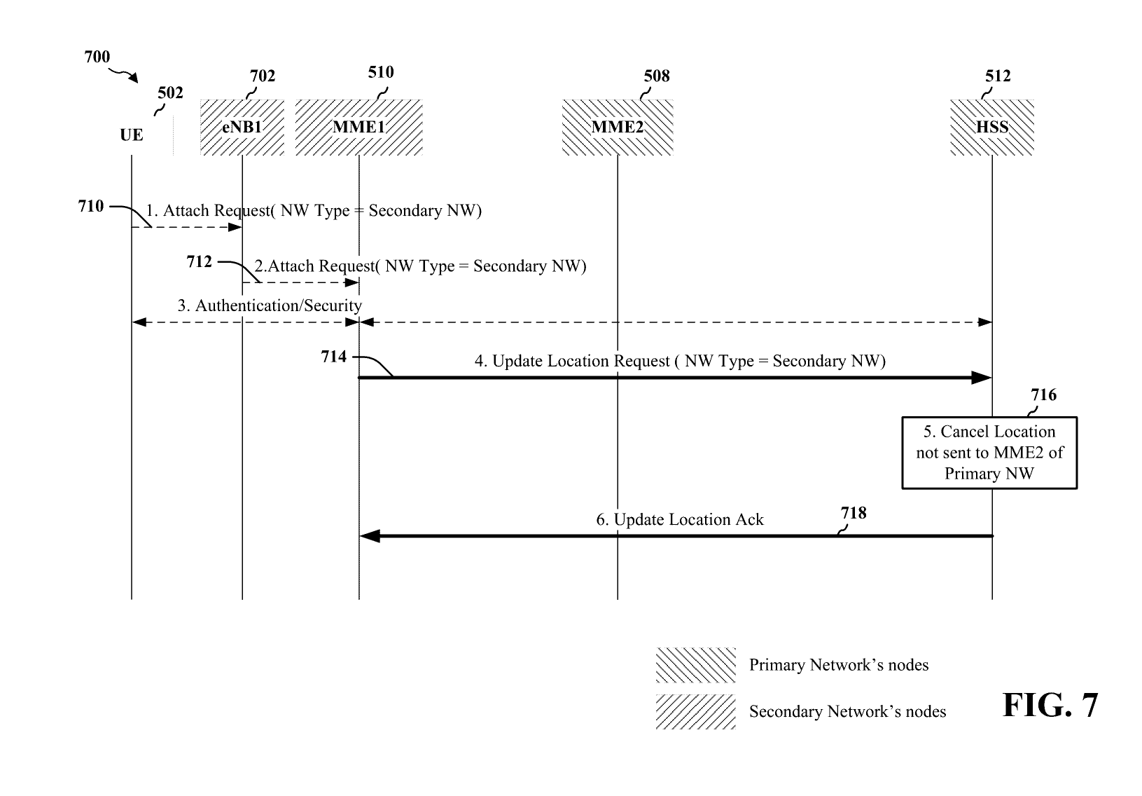

Specific examples of maintaining data continuity when switching a portion of a UE connection between different networks are shown in FIGS. 7-9. FIG. 7 illustrates an example system 700 for updating a location of at least a portion of a connection of a UE to a different network. System 700 includes a UE 502 that communicates with an eNB 702 to access MME 510, which can be an MME of a different (e.g., secondary) network. System 700 also includes MME 508, which relates to a network from which the UE is performing handover (e.g., primary network), and an HSS 512. UE 502 sends an Attach Request 710 to eNB 702 of another network to handover at least a portion of a connection of the UE 502 (e.g., at least a data portion). UE 502 specifies a network type of “secondary network” in the Attach Request 710. This can indicate that the request relates to adding a secondary network to the connection of the UE 502 (e.g., for the data portion of the connection where the UE 502 retains a connection with a primary network for another portion of the connection). It is to be appreciated that the Attach Request 710 can relate to one of multiple radios of the UE 502 and/or a portion of a connection of the UE 502 that is with the MNO network before the handover.

eNB 702 can send at least a portion of the attach request to MME 510 of the different network at 712. The attach request 712 can additionally indicate the “secondary network” type. MME 510 can perform authentication/security for the UE 502 with HSS 512, and MME 510 can send an Update Location Request to the HSS 512 at 714, where the request indicates a network type as “secondary network.” The HSS 512 can store the MME Identity of MME 510 as the secondary MME for the UE 502 based at least in part on receiving the request. HSS 512 may already have a MME identity (e.g., of MME 508) for this UE 502 for a primary network, which is stored as the UE's primary MME in the HSS 512. Based on receiving the Update Location Request, the HSS 512 can maintain data continuity for the UE 502 (e.g., based on the request indicating the “secondary network” type). For example, this can include HSS 512 not sending a Cancel Location Request to MME 508, at 716. This allows the MME 508 to maintain a context for the UE 502 in the event the portion of the connection is handed back over to the network of MME 508. As a result of the update location request, HSS 512 can maintain two MME identities for UE 502 (e.g., one Primary MME ID for MME 508 and one Secondary MME ID for MME 510).

As shown at 710 and 712, in a specific example, the Network Type set by MME 510 might depend on information received from the eNB 702 or UE 502 during the Attach procedure, a PDN Connection Setup Procedure, etc. This can be a new field in the Attach Request Message defined in 3GPP. Moreover, for example, the MME 510 may set this field based on whether the Attach Type is set to “Handover” by the UE 502. In addition, for example, the Network Type might not be an explicit field in the Update Location Request but the HSS 512 may determine the Network Type based on the identity of the MME 510 from which the message originates (or its related network). In addition, for example, the absence of this field may indicate that the Network Type is Primary while presence of the field may indicate that the Network Type is Secondary. Thus, in an example, request type determining component 522 can accordingly determine whether the request is to update location to a secondary network, and can thus determine whether to send a Cancel Location Request before or as part of acknowledging the request.

In addition, referring back to FIGS. 5 and 6, for procedures where the HSS 512 uses the Identity of an MME serving a particular UE, the HSS 512 may use one or both MME identities for MEs 508 and 510 for UE 502 depending on the procedure. For example, method 600 may optionally include, at Block 616, updating a UE profile for the first node and the second node. In an aspect, UE profile updating component 526, e.g., in conjunction with the one or more processors 503 and/or memory 505, may update the UE 502 profile for the first node (e.g., MME 508) and the second node (e.g., MME 510). For example, while updating the HSS 512 user profile stored in the MME for UE 502, the HSS 512 may use both MME Identities to update the profile to both MME 508 and MME 510, as it may be important for both MMEs to get updates information about the UE subscription, etc. In other words, for example, the UE profile updating component 526 may send profile updates regarding subscriptions at the UE 502 to both MME 508 and MME 510 (and/or other MMEs having an identity stored for UE 502 at HSS 512) at least while the UE 502 is communicating with the networks 504, 506.

In another example in this regard, method 600 may optionally include, at Block 618, sending routing information for LCS to a gateway mobile location center (GMLC) for the first node. In an aspect, routing information component 528, e.g., in conjunction with the one or more processors 503, memory 505, and/or communications component 509, may send the routing information for LCS to the GMLC for the first node (e.g., MME 508), but perhaps not for the second node (e.g., MME 510), as the secondary network (e.g., network 506) might not support location services for this UE 502. In one example, routing information component 528 may determine whether the GMLC for the first node (e.g., MME 508) and/or the second node (e.g., MME 510) support location services for the UE 502 in determining whether to transmit routing information for LCS thereto. In another example, routing information component 528 may send routing information to the GMLC for the node associated with the primary network (e.g., the network operated by a MNO of the UE 502).

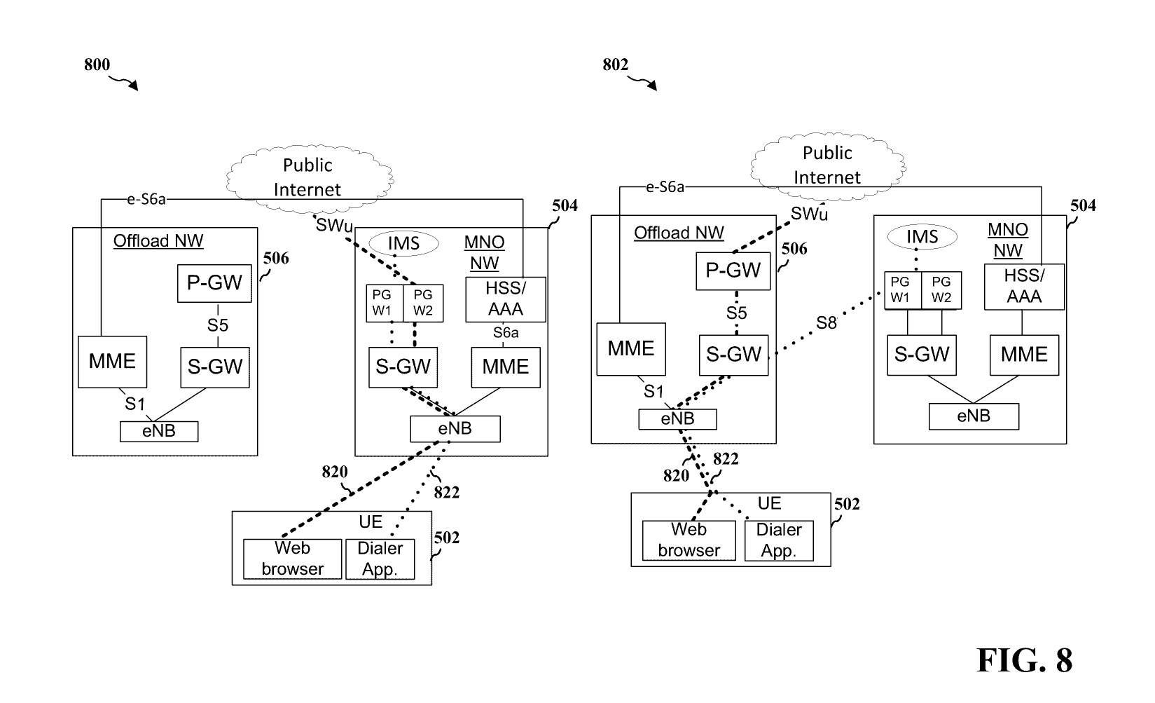

FIG. 8 illustrates example systems 800 and 802 for maintaining data continuity for a UE selecting between different networks. System 800 shows a UE 502 that is connected to the MNO Network 504 and has established two PDN connections (e.g., an Internet connection 820 and an IMS connection 822). System 802 shows the PDN connections 820 and 822 when the UE 502 moves to the Offload Network 506. The Internet PDN connection 820 is locally routed through the Offload Network 506 and the IMS PDN connection 822 is routed through the MNO Network 504 (e.g., the HPLMN). Maintaining IP address continuity for the IMS PDN connection 822 may be essential for seamless user experience of voice and video calls or other IMS services, PSS services, etc. when the UE 502 is offloaded from the MNO to the offload network.

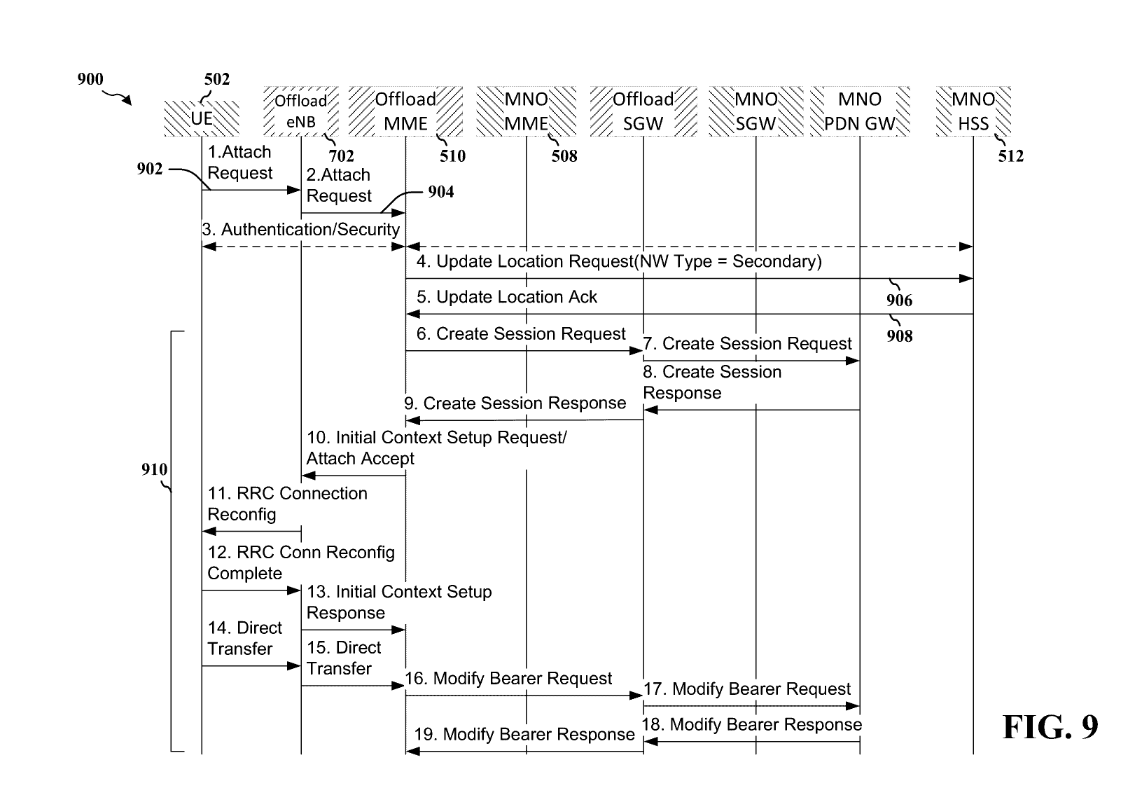

FIG. 9 illustrates an example system 900 for handing over the IMS PDN connection as the UE 502 moves from the MNO network 504 to the offload network 506. Similarly to FIG. 7, system 900 can include UE 502 that offloads to an offload eNB 702, an offload MME 510, MN) MME 508, and HSS 512. The UE 502 can initiate the attach procedure by transmitting the Attach Request 902 to the Offload Network eNB 702. In the EPS session management (ESM) message container of the Attach Request the Request Type is set to “handover” and/or Network Type is set to “secondary network.” Note that the “handover” indication is defined in 3GPP TS 23.401, for example, however it is currently used for Non-3GPP mobility (S2a, S2b based mobility). It is to be appreciated that the Attach Request 902 can relate to one of multiple radios of the UE 502 and/or a portion of a connection of the UE 502 that is with the MNO network before the handover. MME 510 can send an Update Location Request to the HSS 512 at 906 indicating that the request type as “handover” and/or the Network Type is “secondary network” (which may be a newly defined field for the Update Location Request). If the “handover” and/or “secondary network” indication are set, the HSS 512 will not send Cancel Location to Primary MME (e.g., MME 508), as described. The HSS 512 may respond to the Offload MME 510 with Update Location Acknowledgement (Ack) at 908, which can include subscription data for the UE 502. The subscription data can include the PDN gateway identity for one or more access point names (APNs), which may have been included in the Update Location Request. The remaining steps 910 are as defined in 3GPP TS 23.401 for completing the attach request, other than some steps may be optional (such as deleting a bearer after modify bearer response is sent to the Offload SGW).

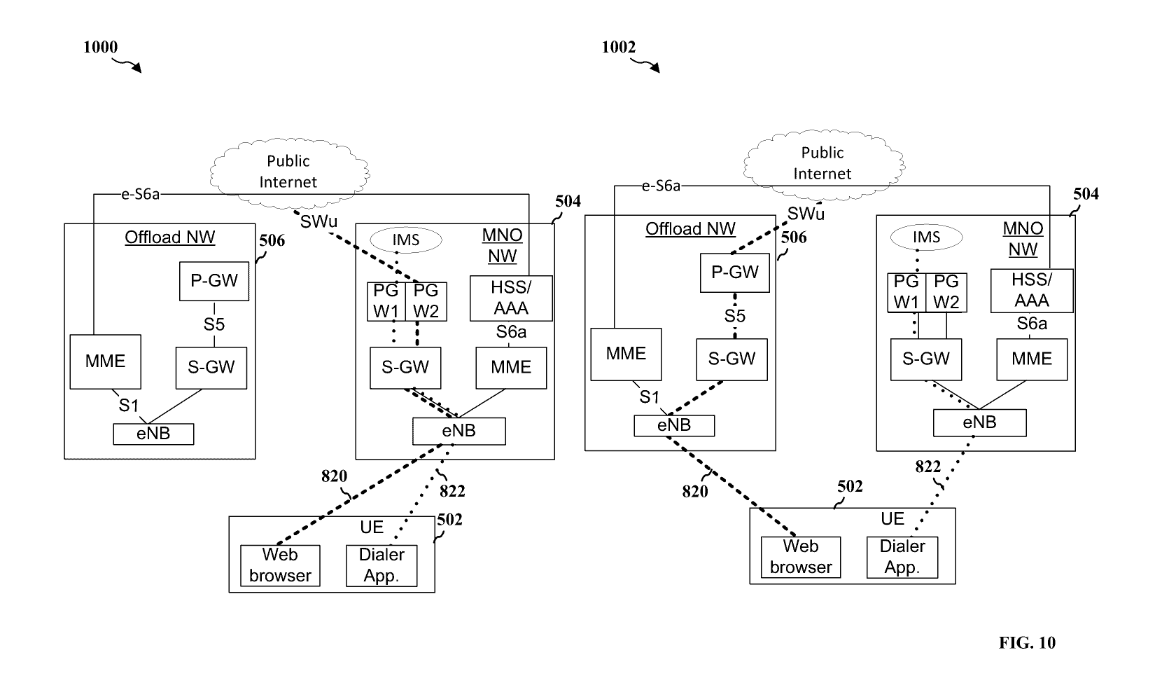

FIG. 10 illustrates example systems 1000 and 1002 for maintaining data continuity for one of multiple radios of a UE selecting between different networks. System 1000 shows a UE 502 that is connected to the MNO Network 504 and has established two PDN connections (e.g., an Internet connection 820 and an IMS connection 822) via different radios, one corresponding to a web browser and one to a dialer application. System 1002 shows the PDN connections 820 and 822 when the UE 502 moves one radio to the Offload Network 506. The IMS PDN connection 822 remains on the dialer application and is routed through the MNO Network 504 (e.g., the HPLMN). The Internet PDN connection 820 for the web browser is transferred to another radio and is locally routed through the Offload Network 506.

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described herein that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for maintaining data continuity for a user equipment (UE), comprising:
receiving, at a first node of a first network, a request from at least one of a second node of the first network or a second network to update a location of the UE;
determining a type of the request based at least in part on an identifier in the request; and
acknowledging the request without instructing a third node of the first network or the second network to cancel a context of the UE based at least in part on the type of the request.

2. The method of claim 1, wherein the identifier identifies a network type of a network of the second node.

3. The method of claim 2, wherein the network type of the second network is a secondary network and the network type of the first network is a primary network, and wherein the request relates to updating the location of a portion of a connection with the UE from the primary network to the secondary network.

4. The method of claim 1, wherein the identifier identifies a type of attach request initiated by the UE, wherein the request is based at least in part on the attach request.

5. The method of claim 4, wherein the type of the attach request is a handover attach request.

6. The method of claim 1, wherein the identifier identifies the second node, and wherein determining the type of the request comprises determining that the request is related to handover where the identifier corresponds to a network different from the first network.

7. The method of claim 1, wherein the first node is a home subscriber server (HSS), the second node is a mobility management entity (MME), and the request is an Update Location Request.

8. The method of claim 1, further comprising maintaining, at the first node, a first identifier for the first node and a second identifier for the second node based at least in part on the type of the request.

9. The method of claim 8, further comprising updating a profile of the UE at the first node and updating the profile of the UE to the second node based on the first identifier and the second identifier.

10. The method of claim 8, further comprising sending routing information for location services from the first node to a gateway mobile location center based on the first identifier and the second identifier.

11. The method of claim 1, wherein the request corresponds to updating a location stored for one of a plurality of radios for the UE.

12. An apparatus for maintaining data continuity for a user equipment (UE), comprising:
at least one processor coupled to a memory via a bus, wherein the at least one processor is operable to:
receive, at a first node of a first network, a request from at least one of a second node of the first network or a second network to update a location of the UE;
determine a type of the request based at least in part on an identifier in the request; and
acknowledge the request without instructing a third node of the first network or the second network to cancel a context of the UE based at least in part on the type of the request.

13. The apparatus of claim 12, wherein the identifier identifies a network type of a network of the second node.

14. The apparatus of claim 13, wherein the network type of the second network is a secondary network and the network type of the first network is a primary network, and wherein the request relates to updating the location of a portion of a connection with the UE from the primary network to the secondary network.

15. The apparatus of claim 12, wherein the identifier identifies a type of attach request initiated by the UE, wherein the request is based at least in part on the attach request.

16. The apparatus of claim 15, wherein the type of the attach request is a handover attach request.

17. The apparatus of claim 12, wherein the identifier identifies the second node, and wherein the at least one processor is operable to determine the type of the request at least in part by determining that the request is related to handover where the identifier corresponds to a network different from the first network.

18. The apparatus of claim 12, wherein the first node is a home subscriber server (HSS), the second node is a mobility management entity (MME), and the request is an Update Location Request.

19. The apparatus of claim 12, wherein the at least one processor is further operable to maintain, at the first node, a first identifier for the first node and a second identifier for the second node based at least in part on the type of the request.

20. The apparatus of claim 19, wherein the at least one processor is further operable to update a profile of the UE at the first node and update the profile of the UE to the second node based on the first identifier and the second identifier.

21. The apparatus of claim 19, wherein the at least one processor is further operable to send routing information for location services from the first node to a gateway mobile location center based on the first identifier and the second identifier.

22. The apparatus of claim 12, wherein the request corresponds to updating a location stored for one of a plurality of radios for the UE.

23. An apparatus for maintaining data continuity for a user equipment (UE), comprising:
means for receiving, at a first node of a first network, a request from at least one of a second node of the first network or a second network to update a location of the UE;
means for determining a type of the request based at least in part on an identifier in the request; and
means for acknowledging the request without instructing a third node of the first network or the second network to cancel a context of the UE based at least in part on the type of the request.

24. The apparatus of claim 23, wherein the identifier identifies a network type of a network of the second node.

25. The apparatus of claim 23, wherein the identifier identifies a type of attach request initiated by the UE, wherein the request is based at least in part on the attach request.

26. The apparatus of claim 23, wherein the identifier identifies the second node, and wherein the means for determining determines that the request is related to handover where the identifier corresponds to a network different from the first network.

27. A computer-readable storage medium comprising computer-executable code for maintaining data continuity for a user equipment (UE), the code comprising:
code for receiving, at a first node of a first network, a request from at least one of a second node of the first network or a second network to update a location of the UE;
code for determining a type of the request based at least in part on an identifier in the request; and
code for acknowledging the request without instructing a third node of the first network or the second network to cancel a context of the UE based at least in part on the type of the request.

28. The computer-readable storage medium of claim 27, wherein the identifier identifies a network type of a network of the second node.

29. The computer-readable storage medium of claim 27, wherein the identifier identifies a type of attach request initiated by the UE, wherein the request is based at least in part on the attach request.

30. The computer-readable storage medium of claim 27, wherein the identifier identifies the second node, and wherein the code for determining determines that the request is related to handover where the identifier corresponds to a network different from the first network.
